(19) United States
(12) Patent Application Publication
(10) Pub. No.: US 2011/0162958 A1
(43) Pub. Date: Jul. 7, 2011

(54) PLASMA DECOMPOSITION APPARATUS AND METHOD FOR CARBON DIOXIDE

(75) Inventors: Moon-Ki Cho, Seoul (KR); Han-Young Kang, Anyang-si (KR)

(73) Assignee: Moon-Ki CHO, Seoul (KR)

(21) Appl. No.: 12/682,592

(22) PCT Filed: Oct. 6, 2008
(86) PCT No.: PCT/KR08/05854

§ 371 Date: Apr. 10, 2010

(30) Foreign Application Priority Data
Oct. 11, 2007 (KR) 10-2007-0102513

(51) Int. Cl. C01B 13/02; C01B 31/00; B01J 19/08; B82Y 30/00

(52) U.S. Cl. 204/173; 422/186.04; 977/742

(57) ABSTRACT

A plasma decomposition apparatus and method for carbon dioxide decomposes carbon dioxide in a non-thermal plasma state into carbon and oxygen. The apparatus includes: a reactor for decomposing carbon dioxide with an inlet for inflow of carbon dioxide and a outlet for discharge of carbon and oxygen; a plurality of anodes placed in the reactor, having a rod shape elongated in a length direction; a plurality of cathodes placed among the plurality of anodes in the reactor, having a rod shape elongated in the length direction; and a power source applying a predetermined voltage between the plurality of anodes and the plurality of cathodes.

### TECHNICAL FIELD

The present invention relates to a plasma decomposition apparatus and method for carbon dioxide, and more particularly, to an apparatus and method for decomposing carbon dioxide in a non-thermal plasma state into carbon and oxygen.

### BACKGROUND ART

Currently, most energy is obtained from heat emitted by burning fossil fuels, in which carbon and hydrogen are combined, such as oil, coal, and natural gas. The burning fossil fuels react with oxygen and emit carbon dioxide during burning processes, and the emitted carbon dioxide is accumulated in the atmosphere to result in global warming.

Carbon dioxide is a very stable material that is hard to decompose. Accordingly, a method to isolate and store carbon dioxide is currently being used. That is, carbon dioxide is captured in facilities such as coal-fired plants where carbon dioxide is generated in volume and then embedded in deep geological layers of land or ocean.

However, this method does not basically reduce the amount of carbon dioxide and has drawbacks of a high cost.

### DETAILED DESCRIPTION

### Technical Problem

Therefore, it is an object of the present invention to provide a plasma decomposition apparatus and method for carbon dioxide that decomposes carbon dioxide in a non-thermal plasma state into carbon and oxygen.

It is another object of the present invention to provide a plasma decomposition apparatus and method for decomposing carbon dioxide and obtaining carbon and oxygen that are recyclable. The obtained carbon may be used as a material for carbon nanotubes.

### Technical Solution

To achieve these and other objects, a carbon dioxide decomposition apparatus according to an aspect of the present invention includes: a reactor for decomposing carbon dioxide with an inlet for inflow of carbon dioxide and a outlet for discharge of carbon and oxygen; a plurality of anodes placed in the reactor, and having a rod shape elongated in a length direction; a plurality of cathodes placed among the plurality of anodes in the reactor, and having a rod shape elongated in the length direction; and a power source applying a predetermined voltage between the plurality of anodes and the plurality of cathodes.

A carbon dioxide reservoir may be placed to connect with the inlet of the reactor, and stores carbon dioxide and provides the reactor with carbon dioxide.

Further, the apparatus preferably has a carbon separating device that is connected with the outlet of the reactor and separates carbon from gases discharged. The carbon separating device separates carbon as a cyclone separating type. The apparatus has a carbon dioxide/oxygen separating device that separates oxygen from carbon dioxide among the discharged gases. The carbon dioxide that is discharged from the carbon dioxide/oxygen separating device returns to the carbon dioxide reservoir or directly to the reactor.

A plasma decomposition method for carbon dioxide according to another aspect of the present invention includes the steps of: flowing carbon dioxide into a reactor having anodes and cathodes; decomposing carbon dioxide in a non-thermal plasma state into carbon and oxygen when the anodes and cathodes are kept at a predetermined voltage; and discharge carbon and oxygen that are decomposed and carbon dioxide that is not decomposed. At this time, carbon dioxide that is not decomposed is discharged.

Before the inflow of carbon dioxide into a reactor, a step of purifying carbon dioxide may be performed. After the discharge of carbon and oxygen, the step of separating carbon from gases may be performed. Furthermore, carbon dioxide may be separated from the discharged gases and then returned to the reactor.

### Advantageous Effects

A carbon dioxide decomposition apparatus according to the present invention can decompose carbon dioxide by making carbon dioxide exist in a non-thermal plasma state. Therefore, carbon dioxide that is mainly responsible for global warming is basically reduced.

Further, the decomposed carbon and oxygen can be recycled. Particularly, it has an advantage that carbon obtained from pure carbon dioxide may be used as a material for carbon nanotubes.

### BRIEF DESCRIPTION OF THE DRAWINGS

FIG. 1 shows a schematic diagram of carbon dioxide plasma decomposing apparatus according to an embodiment of the present invention;

FIG. 2 shows a sectional interior view of a reactor.

### BEST MODE

The present invention will be described more fully hereinafter with reference to the accompanying drawings, in which exemplary embodiments of the present invention are shown.

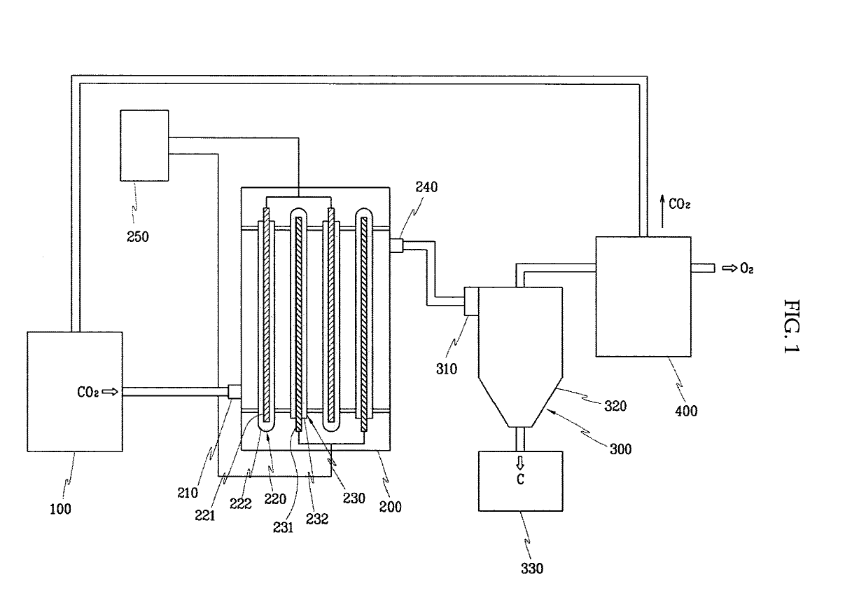

First referring to FIG. 1, a carbon dioxide plasma decomposing apparatus according to an embodiment of the present invention will be described. The carbon dioxide plasma decomposing apparatus includes a carbon dioxide reservoir 100, a reactor 200, a carbon separating device 300, and a carbon dioxide/oxygen separating device 400.

The carbon dioxide reservoir 100 stores carbon dioxide that is captured in coal-fired plants and so forth. The carbon dioxide stored in the carbon dioxide reservoir 100 is preferably pure carbon dioxide that is purified by high-efficiency membranes. Alternatively, a purifying device may be provided to purify carbon dioxide before flowing it into the reactor 200.

The reactor 200 in which carbon dioxide is decomposed includes an inlet 210 connected to the carbon dioxide reservoir 100 for carbon dioxide to flow in, and an outlet 240 to drain carbon and oxygen that are decomposed. A plurality of anodes 220 and a plurality of cathodes 230 are elongated in a length direction and disposed at the interior of the reactor 200. A power supply 250 is connected outside of the reactor to supply a predetermined voltage between the plurality of anodes 220 and the plurality of cathodes 230.

Each anode 220 has a cylindrical anode rod 221 elongated in the length direction and an insulator 222 encompassing the anode rod. The anode rod 221 is made of a conductive material that is preferably TiO₂. The insulator 222 is preferably made of ceramics.

Each cathode 223 has a cylindrical cathode rod 231 elongated in the length direction and an insulator 232 encompassing the cathode rod. The cathode rod 231 is made of a conductive material having high conductivity such as copper, silver, platinum, or TiO₂.

Specifically, TiO₂ generates free electrons with energy of 3 eV in response to electromagnetic waves having a wavelength below 380 nm. Since the free electron energy of 3 eV is more than the dissociation energy of carbon dioxide, which is 2.82 eV, it is preferred to use TiO₂ as a cathode rod 231.

The insulator 232 is made of ceramics, quartz, Pyrex, etc., and preferably ceramics.

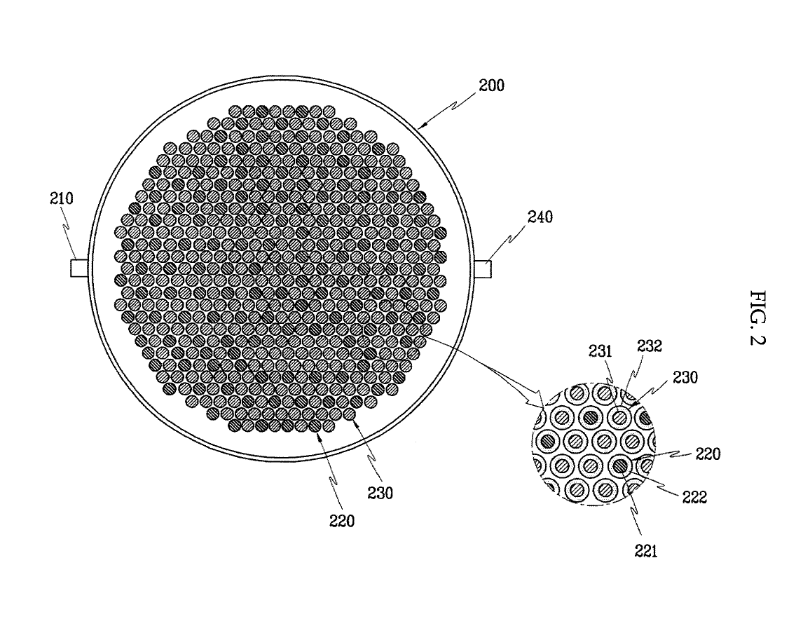

The numbers of the plurality of anodes 220 and the plurality of cathodes 230 are suitably determined according to a specific design. When the plurality of cathodes 230 are disposed to encompass the plurality of anodes 220 in a view from the length direction, the decomposition of carbon dioxide is accommodated. It is preferred that the number of the plurality of cathodes 230 is equal to or more than the number of the plurality of anodes 220. FIG. 2 shows an exemplary arrangement of the anodes 220 and cathodes 230.

The power supply 250 is connected to the anodes 220 and cathodes 230, and provides them with a direct accelerating voltage V. The power supply 250 may employ a general alternating power supply that generates 220 V AC, for example, and generates a high direct voltage as an accelerating voltage required for decomposition of carbon dioxide that is converted and rectified.

Carbon dioxide stored in the carbon dioxide reservoir 100 is provided into the interior of the reactor 200 through an inlet 320. It is possible to provide a separate inlet pump in the reactor 200 for inflow of carbon dioxide. Alternatively, an inflow device 310 that will be described later may be used to accommodate carbon dioxide to enter the reactor. Carbon dioxide that enters the reactor comes to be in a non-thermal plasma state by the accelerating voltage between the anodes 220 and cathodes 230, and is then decomposed into carbon and oxygen by electrons generated from the cathodes 230.

At this time, the energy E of the electron generated from the cathodes 230 preferably has a range of 0.5-4 KeV, and more preferably 0.5-1 KeV.

For this range of the electron energy, the accelerating voltage V_{acc} applied between the anodes 220 and cathodes 230 is obtained as below.

When the energy E of the electron is 0.5 KeV, the momentum of the electron is calculated as follows:

Electron Energy E=0.5 KeV=8.01×10⁻¹⁷ J,

Electron Momentum p=√(2mE)=1.207×10⁻²³ kg m/sec

where m is a mass of the electron.

Since e V_{acc}=h v, the accelerating voltage V_{acc} is then

V_{acc}=c×p/e,

where e is a quantity of electron charge, h is Planck's constant, and c is the velocity of light.

The accelerating voltage V_{acc} is obtained by substitution of the electron momentum above.

V_{acc}=22.6 kV

Similarly, when the energy E of the electron is 4.0 KeV, the accelerating voltage V_{acc} applied between the anodes 220 and cathodes 230 is obtained as 63.6 kV.

Therefore, the accelerating voltage applied between the anodes 220 and cathodes 230 preferably ranges from 22.5 to 63.6 kV, and more preferably ranges from 25 to 50 kV.

Since the accelerating voltage between the anodes 220 and cathodes 230 is maintained at a high voltage such as 22.5-63.6 kV, electrons having more energy than 2.82 eV, which is the dissociation energy of carbon dioxide, are emitted to decompose carbon dioxide into carbon and oxygen.

The outlet 240 of the reactor 200 is connected to a carbon separating device 300. The carbon separating device 300 has an inflow device 310 and a cyclone separator 320. The inflow device 310 sucks the decomposed carbon and oxygen and undecomposed carbon dioxide to drain it from the outlet 240 of the reactor 200. In this embodiment, although the inflow device 310 is disposed at the carbon separating device 300, it is possible to provide the inflow device at the carbon dioxide/oxygen separating device 400 or at any part behind the carbon dioxide/oxygen separating device 400 according to a desired design.

The carbon and oxygen that have been decomposed and the carbon dioxide that has not yet been decomposed from the outlet 240 enters the cyclone separator 320. The cyclone separator 320 separates solid carbon from gases of oxygen and carbon dioxide. The cyclone separator 320 separates solid carbon from gases by a known cyclone separating method.

Carbon separated from the cyclone separator 320 is drained to and stored in a carbon storage part 330. The carbon stored in the carbon storage part 330 is pure carbon since it originates from rectified pure carbon dioxide. The decomposed carbon may be used as a material for carbon nanotubes.

The oxygen and carbon dioxide drained from the cyclone separator 320 enters the carbon dioxide/oxygen separator 400 and are then separated from each other. The carbon dioxide/oxygen separator 400 separates the gases by a pressure swing adsorption (PSA) method.

The oxygen drained from the carbon dioxide/oxygen separator 400 may be stored in an oxygen tank that is not shown in the drawings, or may be discharged into the air. The carbon dioxide drained from the carbon dioxide/oxygen separator 400 is stored in the carbon dioxide reservoir 100 again and then passes through the decomposition process again. Alternatively, the carbon dioxide drained from the carbon dioxide/oxygen separator 400 directly returns to the reactor 200 and then passes through the decomposition process again.

Therefore, the carbon dioxide decomposing apparatus completely decomposes carbon dioxide into carbon and oxygen.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for decomposing carbon dioxide, comprising:
a reactor for decomposing carbon dioxide, comprising an inlet for inflow of carbon dioxide and a outlet for discharge of carbon and oxygen that are decomposed from carbon dioxide;
a plurality of anodes placed in the reactor, having a rod shape elongated in a length direction;
a plurality of cathodes placed among the plurality of anodes in the reactor, having a rod shape elongated in the length direction; and
a power source applying a voltage between the plurality of anodes and the plurality of cathodes.

2. The apparatus as recited in claim 1, further comprising
a carbon dioxide reservoir, connected with the inlet of the reactor, for storing carbon dioxide and providing the reactor with carbon dioxide.

3. The apparatus as recited in claim 2, wherein carbon dioxide reserved in the carbon dioxide reservoir has been purified.

4. The apparatus as recited in claim 1, further comprising
a carbon separating device connected with the outlet of the reactor, for separating carbon from gases.

5. The apparatus as recited in claim 4, wherein carbon separated from the carbon separating device is used as a material for carbon nanotubes.

6. The apparatus as recited in claim 4, wherein the carbon separating device separates carbon as a cyclone separating type.

7. The apparatus as recited in claim 4, further comprising
a carbon dioxide/oxygen separating device connected with the carbon separating device, for separating oxygen from carbon dioxide.

8. The apparatus as recited in claim 7, wherein carbon dioxide that is discharged from the carbon dioxide/oxygen separating device returns to the reactor.

9. The apparatus as recited in claim 7, wherein the carbon dioxide/oxygen separating device separates oxygen from carbon dioxide with a pressure swing adsorption (PSA) method.

10. The apparatus as recited in claim 1, wherein each of the plurality of anodes or cathodes comprises:
a cylindrical rod made of a conductive material; and
an insulator encompassing the cylindrical rod.

11. The apparatus as recited in claim 10, wherein the conductive material is titanium dioxide, and the insulator is made of ceramics.

12. The apparatus as recited in claim 1, wherein the plurality of cathodes are disposed to encompass the anode in a view from the length direction.

13. The apparatus as recited in claim 12, wherein the number of the plurality of cathodes is equal to or more than the number of the plurality of anodes.

14. A method for decomposing carbon dioxide comprising:
flowing carbon dioxide into a reactor having anodes and cathodes;
decomposing carbon dioxide in a non-thermal plasma state into carbon and oxygen when the anodes and cathodes are kept at a predetermined voltage; and
discharging carbon and oxygen that are decomposed and carbon dioxide that is not decomposed.

15. The method as recited in claim 14, further comprising, before flowing carbon dioxide into a reactor having anodes and cathodes,
purifying the carbon dioxide.

16. The method as recited in claim 14, further comprising, after discharging carbon and oxygen that are decomposed and carbon dioxide that is not decomposed,
separating the carbon.

17. The method as recited in claim 16, wherein the separated carbon is used as a material for carbon nanotubes.

18. The method as recited in claim 14, further comprising, after discharging carbon and oxygen that are decomposed and carbon dioxide that is not decomposed:
separating the carbon dioxide; and
returning the separated carbon dioxide to the reactor.
